(19) United States
(12) Patent Application Publication
(10) Pub. No.: US 2005/0274157 A1
(43) Pub. Date: Dec. 15, 2005

(54) Washing machine having detergent supply device

(75) Inventor: Yoon Seok Yang, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/151,246

(22) Filed: Jun. 14, 2005

(30) Foreign Application Priority Data
Jun. 15, 2004 (KR) 10-2004-0044040

(51) Int. Cl. B08B 3/12

(52) U.S. Cl. 68/17 R

(57) ABSTRACT

A washing machine having a detergent supply device for supplying detergent, filled in a detergent container, into a washing tub, in a mixed state with wash water. The detergent supply device includes a housing, a detergent container, and a restrictive element. The housing has a plurality of inlets connected with respective water supply pipes, and an outlet connected with a washing tub. The detergent container is detachably inserted in the housing and internally defines a liquid detergent receiving chamber. In the liquid detergent receiving chamber is provided a discharge member for discharging liquid, filled in the liquid detergent receiving chamber, into the water tub. The restrictive element is adapted to minimize fluctuation of the liquid filled in the detergent container when an external force acts on the detergent container.

### CROSS-REFERENCE TO RELATED APPLICATION

This application claims the benefit of Korean Patent Application No. 2004-44040, filed on Jun. 15, 2004 in the Korean Intellectual Property Office, the disclosure of which is incorporated herein by reference.

### BACKGROUND OF THE INVENTION

1. Field of the Invention

The present invention relates to a washing machine, and more particularly, to a washing machine having a detergent supply device for mixing detergent, filled in a detergent container, with wash water, and supplying the mixed detergent and wash water into a washing tub.

2. Description of the Related Art

In general, washing machines wash laundry using a frictional force caused by simultaneously agitating the laundry, detergent and wash water, contained in a washing tub, upon receiving driving power from a motor. The washing machines employ a detergent supply device, which is adapted to supply the detergent into a water tub in an evenly mixed state along with the wash water during a water supply cycle.

In the case of a drum-type washing machine, the detergent supply device is mounted in an upper front side of a body. The detergent supply device includes a box-shaped housing having an open front surface, and a separable detergent container having a drawer shape to be pushed into or pulled out of the housing through the open front surface. In a rear upper portion of the housing are formed inlets for use in the connection of water supply pipes. Through the water supply pipes, the wash water is supplied into the detergent container. In a bottom rear portion of the housing is formed an outlet for use in the connection of a connection pipe. The wash water, having passed through the detergent container located in the housing, is supplied into the water tub of the washing machine through the connection pipe.

The detergent container is internally sectionalized into a plurality of detergent receiving chambers for separately sorting and receiving various different types of detergents. Recently, in order to use liquid detergents, such as rinsing agents and bleaching agents, there has been developed a washing machine having a detergent supply device in which a liquid detergent receiving chamber is defined in a detergent container. The liquid detergent, filled in the liquid detergent receiving chamber of the detergent container, is mixed with the wash water supplied into the liquid detergent receiving chamber. The mixture of the wash water and liquid detergent is supplied into the water tub through a discharge opening or siphon at a time when the level of the mixture exceeds a predetermined value.

The above-described detergent supply device, however, has a problem. Specifically in the course of coupling the detergent container, in which the detergents were filled in the respective detergent receiving chambers thereof, into the detergent supply device, the liquid detergent received in the liquid detergent receiving chamber may be unintentionally supplied into the water tub through the discharge opening or siphon during a washing cycle which does not require the liquid detergent. This is due to a fluctuation in the level of the liquid detergent received in the liquid detergent receiving chamber.

### SUMMARY OF THE INVENTION

Accordingly, it is an aspect of the present invention to overcome the above-mentioned problem.

It is another aspect of the invention to provide a washing machine having a detergent supply device which can reduce the fluctuation in level of liquid detergent caused as the liquid detergent tilts from side to side, thereby preventing the liquid detergent from being prematurely supplied into a water tub during a cycle other than a predetermined washing cycle.

Additional aspects and/or advantages of the invention will be set forth in part in the description which follows and, in part, will be apparent from the description, or may be learned by practice of the invention.

The forgoing and/or other aspects may be achieved by providing a washing machine having a washing tub and a detergent supply device, the detergent supply device including: a plurality of water supply pipes, a housing having a plurality of inlets respectively connected with the water supply pipes, and an outlet connected with the washing tub; and a detergent container detachably inserted in the housing and internally defining a liquid detergent receiving chamber, the detergent container including: a discharge member for discharging a liquid detergent, supplied into the liquid detergent receiving chamber, into the washing tub when the level of the liquid exceeds a predetermined value; and a dividing member adapted to divide the liquid detergent receiving chamber into a space having the discharge member and a space having no discharge member, thereby restricting free movement of the liquid between both the spaces.

The discharge member may be a siphon. The siphon may be provided with a level marker for displaying the appropriate level of the liquid detergent supplied in the liquid detergent receiving chamber. The dividing member may be integrally formed with the level marker. The level marker may be formed with a fixture portion for fixing the level marker to the detergent container.

The dividing member may be a partition adapted to divide the liquid detergent receiving chamber into front and rear spaces. The partition may have a width narrower than a width of the liquid detergent receiving chamber by a predetermined distance, thereby defining a liquid passage on a side thereof. The dividing member may be vertically installed in the center of the liquid detergent receiving chamber.

### BRIEF DESCRIPTION OF THE DRAWINGS

These and/or other aspects and advantages of the invention will become apparent and more easily appreciated from the following description of the embodiments, taken in conjunction with the accompanying drawings of which:

FIG. 1 is a perspective view illustrating the interior configuration of a washing machine in accordance with a first embodiment of the present invention;

FIG. 2 is an exploded perspective view illustrating a detergent supply device of the washing machine in accordance with the first embodiment of the present invention;

FIG. 3 is a partially cut-away, plan sectional view illustrating a detergent container coupled in the detergent supply device of the washing machine in accordance with the first embodiment of the present invention;

FIG. 4 is a sectional view illustrating a course of adding liquid detergent into the detergent supply device of the washing machine in accordance with the first embodiment of the present invention;

FIG. 5 is a sectional view illustrating the flow of the liquid detergent in a state wherein the detergent container is completely coupled into the detergent supply device of the washing machine in accordance with the first embodiment of the present invention;

FIG. 6 is a sectional view illustrating the supply of the liquid detergent through the detergent supply device of the washing machine in accordance with the first embodiment of the present invention;

FIG. 7 is a perspective view illustrating the interior of a detergent container in accordance with a second embodiment of the present invention; and

FIG. 8 is a sectional view illustrating the flow of liquid detergent in a state wherein the detergent container shown in FIG. 7 is completely inserted in the detergent supply device.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

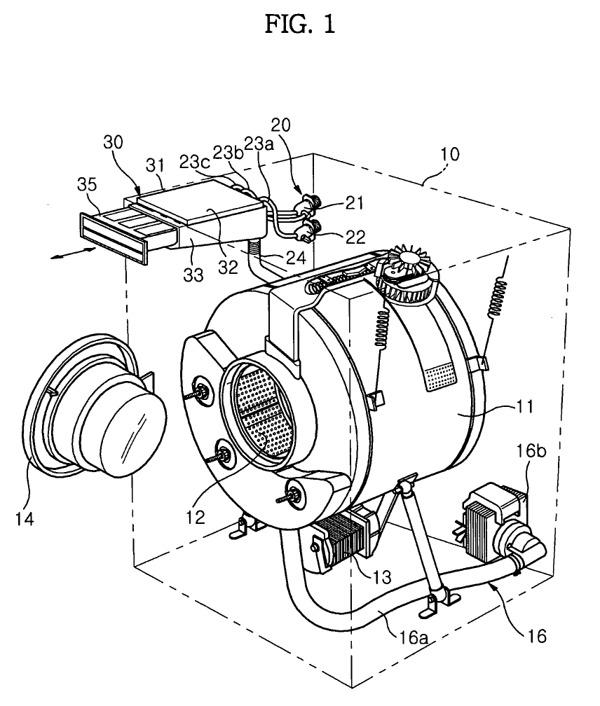

Referring to FIG. 1, illustrating a drum-type washing machine in accordance with a first embodiment of the present invention, the washing machine includes a cylindrical water tub 11 installed in a body 10 to contain wash water, and a cylindrical washing tub 12 rotatably installed in the water tub 11 and formed at a peripheral wall surface thereof with a plurality of spin-dry holes. Below the water tub 11 is provided a driving motor 13, which is adapted to rotate the washing tub 12 installed in the water tub 11 forward or in reverse for performing washing, rinsing and spin-drying operations. Further, openings are provided at respective corresponding front ends of the body 10, water tub 11 and washing tub 12 for putting laundry into the washing tub 12 or taking the laundry out of the washing tub 12. In order to open or close the openings, a door 14 is installed at the front end of the body 10.

Above the water tub 11 are provided a water supply device 20 and a detergent supply device 30, which are adapted to simultaneously supply the wash water and detergent into the water tub 11 in a water supply cycle. Below the water tub 11 is further provided a drainage device 16 for forcibly draining the wash water from the water tub 11 after completion of the washing operation. The drainage device 16 includes a drainage pipe 16a, and a drainage pump 16b.

The water supply device 20 includes a plurality of water supply valves 21 and 22, which are connectable to an external water supply hose (not shown) for controlling the supply of water, a plurality of water supply pipes 23a, 23b and 23c connected between the respective water supply valves 21 and 22 and the detergent supply device 30, and a connection pipe 24 adapted to guide the wash water, having passed through the detergent supply device 30, into the water tub 11.

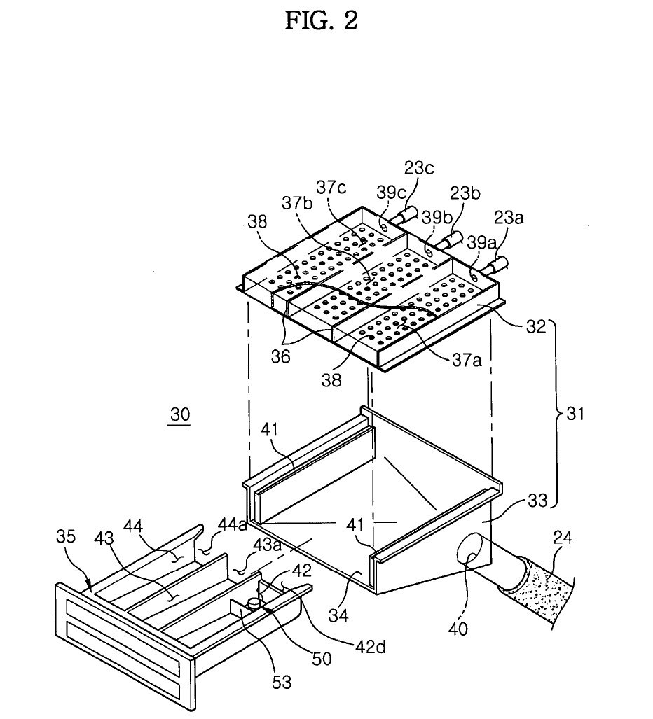

Referring to FIG. 2, the detergent supply device 30 includes a box-shaped housing 31 having an opening 34 formed at a front end thereof, and a detergent container 35 detachably coupled to the housing 31 through the opening 34. In order to allow the detergent container 35 to be pulled out of the housing 31 like a drawer, the detergent supply device 30 is mounted at an upper front side of the body 10.

The housing 31 of the detergent supply device 30 is formed by coupling an upper case 32 with a lower case 33. The lower case 33 has an interior space for receiving the detergent container 35, and is opened at front and upper surfaces thereof. The upper case 32 is coupled to the lower case 33 to cover the open upper surface of the lower case 33.

The upper case 32 internally defines a plurality of water supply channels 37a, 37b and 37c, which are sectionalized by partitions 36. A bottom surface of the upper case 32 is perforated to form a plurality of holes 38, which are adapted to distribute the wash water, which was supplied into the respective water supply channels 37a, 37b and 37c, into the detergent container 35 positioned below the upper case 32. A rear end of the upper case 32 is perforated to form a plurality of inlets 39a, 39b and 39c, to which respective water supply pipes 23a, 23b and 23c are connected for supplying the wash water into the water supply channels 37a, 37b and 37c.

The lower case 33 of the housing 31 is formed at a bottom rear portion thereof with an outlet 40, and to the outlet 40 is connected the connection pipe 24, such that the water inside the lower case 33 can be supplied into the water tub 11. The bottom surface of the lower case 33 is inclined downward toward the outlet 40, in order to secure smooth flow of the wash water into the outlet 40. Along upper ends of both lateral surfaces of the lower case 33 are installed guide rails 41 for guiding the detachment of the detergent container 35.

The detergent container 35 has an open upper surface, and internally defines a plurality of detergent receiving chambers 42, 43 and 44, which are sectionalized by partitions in order to separately sort and receive several different kinds of detergents. The respective detergent receiving chambers 42, 43 and 44 correspond to the respective water supply channels 37a, 37b and 37c defined in the upper case 32, and a bottom surface of the detergent container 35 is inclined downward toward a rear side thereof.

For the discharge of the detergents mixed with the wash water into the lower case 33, the respective detergent receiving chambers 42, 43 and 44 have discharge openings 42d, 43a and 44a, respectively, and the detergent receiving chamber 42 for receiving liquid detergent is internally provided with a siphon 50. With such a configuration, when the wash water is supplied into the detergent container 35 through the respective water supply channels 37a, 37b and 37c positioned in an upper portion of the housing 31, the detergents, filled in the respective detergent receiving chambers 42, 43 and 44, flow toward the outlet 40 of the housing 31 through the discharge openings 43a, 44a and 42d and the siphon 50 in a mixed state with the wash water, thereby being supplied into the water tub 11.

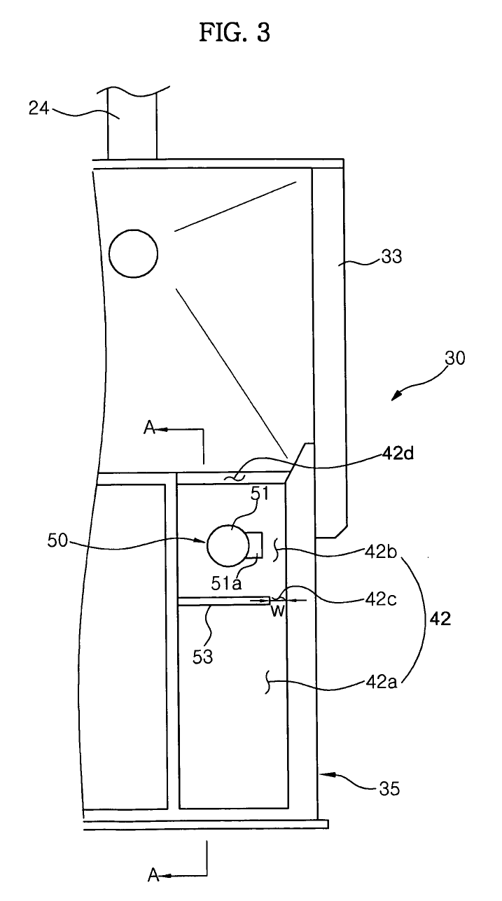

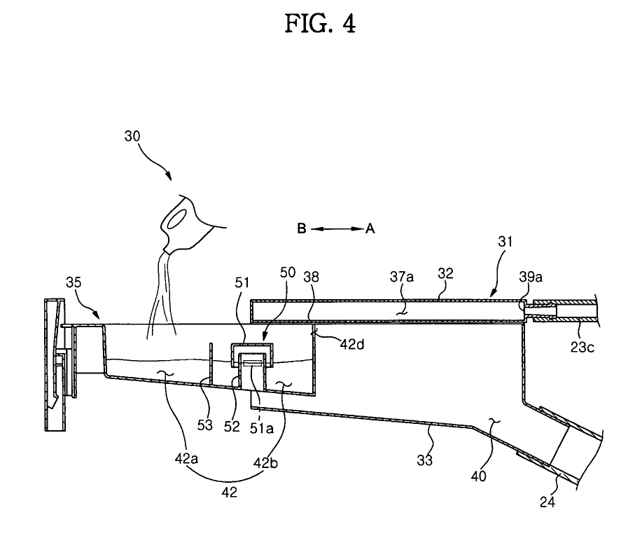

The siphon 50 is a tube adapted to raise liquid upward, and then convey the liquid to a lower level. As shown in FIGS. 3 and 4, the siphon 50 includes a cylindrical upright flow passage tube 52 extending upward from a bottom wall of the liquid detergent receiving chamber 42, and a siphon cap 51 installed at the top of the upright flow passage tube 52.

The siphon cap 51 takes the form of a cylinder having a closed upper surface, and has a diameter larger than that of the upright flow passage tube 52, thereby producing a flow passage between an inner peripheral surface of the siphon cap 51 and an outer peripheral surface of the upright flow passage tube 52. A lower end of the siphon cap 51 is lower than an upper end of the upright flow passage tube 52. Therefore, once the level of the liquid, including the liquid detergent and the wash water, filled in the liquid detergent receiving chamber 42, is higher than the upper end of the upright flow passage tube 52, the liquid starts to be continuously discharged through the upright flow passage tube 52 until the level of the liquid is lower than the lower end of the siphon cap 51. Meanwhile, at a circumferential position of the siphon cap 51 is provided a level marker 51a. The level marker 51a horizontally protrudes outward from the circumferential position of the siphon cap 51 and is adapted to show the appropriate level of the liquid detergent to be supplied into the liquid detergent receiving chamber 42.

The detergent container 35 of the detergent supply device 30 includes a partition 53 located in the liquid detergent receiving chamber 42. The partition 53 is a thin flat plate dividing the liquid detergent receiving chamber 42 into a rear space 42b containing the siphon 50 and a front space 42a not containing the siphon 50. A height of the partition 53, as shown in FIG. 4, is approximately the same as that of an upper end of the siphon cap 51, and a width of the partition 53, as shown in FIG. 3, is narrower by a width ‘w’ than that of the liquid detergent receiving chamber 42. Therefore, a liquid passage 42c is defined beside the partition 53, and serves as a passage for the liquid detergent and wash water between the front and rear spaces 42a and 42b.

If there is a difference in levels of the liquid between the front and rear spaces 42a and 42b of the liquid detergent receiving chamber 42, the liquid flows through the liquid passage 42c to equalize the liquid levels of both the spaces 42a and 42b. In this case, the fact that the liquid detergent, having a high viscosity, flows through the liquid passage 42c having a narrow width (w), means that it is longer than a predetermined time to equalize the liquid levels of both the spaces 42a and 42b.

Now, the detergent and water supply operations of the washing machine having the above-described detergent supply device will be explained.

First, as shown in FIG. 4, as the liquid detergent is added into the front space 42a of the liquid detergent receiving chamber 42, the liquid level of the front space 42a gradually rises. In this case, since the liquid detergent flows from the front space 42a to the rear space 42b of the liquid detergent receiving chamber 42 through the liquid passage 42c (See FIG. 3), although it takes time, the liquid levels of the front and rear spaces 42a and 42b eventually equalize. In this way, if the liquid detergent is filled up to the appropriate level denoted by the level marker 51a, the adding of the liquid detergent is completed, and then the detergent container 35 is pushed into the detergent supply device 30.

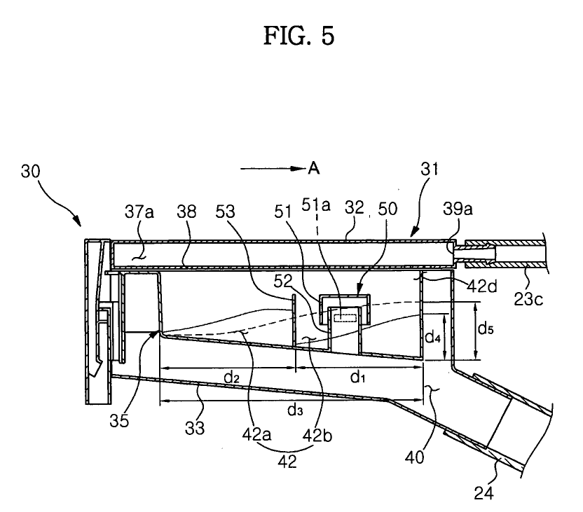

Referring to FIG. 5, after the detergent container 35 is completely pushed into the detergent supply device 30 in a direction marked by arrow (A), movement of the detergent container 35 is stopped, but the liquid detergent filled in the detergent container 35 continues to move in the direction arrow (A) due to momentum. In this case, due to the high viscosity thereof, the liquid detergent causes an inclination in the level thereof as it is pushed in the direction of the arrow (A).

In this case, since the detergent container 35 is provided with the partition 53 which laterally defines the narrow liquid passage 42c (See FIG. 3), rapid movement of the high-viscosity liquid detergent from the front space 42a to the rear space 42b of the detergent container 35 is prevented. Therefore, the front and rear spaces 42a and 42b of the liquid detergent receiving chamber 42 are instantaneously isolated from each other, such that the liquid detergent supplied in the front space 42a forms a curved inclined surface separate from the liquid detergent supplied in the rear space 42b.

Meanwhile, the curved inclined surface of the front or rear space 42a or 42b has the lowermost level at a front end thereof, and the uppermost level at a rear end thereof. An inclination between the lowermost and uppermost levels is variable according to the force acting on the liquid detergent. Therefore, if the same force is applied to the liquid detergent filled in the front and rear spaces 42a and 42b, as a length (d₃) between front and rear ends of the liquid detergent receiving chamber 42 is longer, a difference between the uppermost and lowermost levels increases.

With the use of the partition 53 dividing the liquid detergent receiving chamber 42 into the front and rear spaces 42a and 42b, as shown in FIG. 5, a length (d₁) between front lowermost and rear uppermost positions of the front space 42a, and a length (d₂) between front lowermost and rear uppermost positions of the rear space 42b, are shorter than the length (d₃) of the detergent container 35 when the liquid is inclined throughout the detergent container 35 having no partition 53. Further, compared to a difference (d₅) between the uppermost and lowermost levels in the case of having no partition 53, a difference (d₄) between the uppermost and lowermost levels in the respective front and rear spaces 42a and 42b decreases when the partition 53 is present. Furthermore, the level around the siphon 50 decreases as compared to the case when there is no partition 53, thereby preventing the liquid detergent from being prematurely discharged through the siphon 50 even if the liquid tilts from side to side.

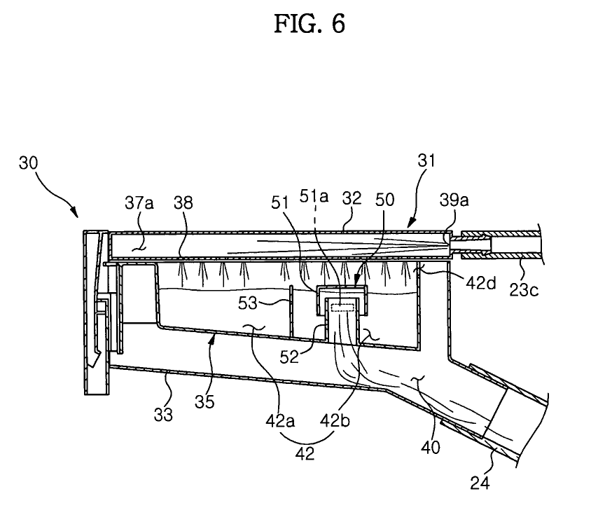

After a predetermined time passes after coupling the detergent container 35 to the detergent supply device 30, the level of the liquid detergent inside the liquid detergent receiving chamber 42 reaches a normal state, and is evenly maintained. Then, if the washing machine is driven to perform the water supply cycle, as shown in FIG. 6, the water is supplied from an external water source (not shown) into the detergent supply device 30, successively through the water supply valves 21 and 22, water supply pipes 23a, 23b and 23c and inlets 39a, 39b and 39c. Next, the water, supplied into the detergent supply device 30 is distributed into the detergent receiving chambers 42, 43 and 44 of the detergent container 35 by passing through at least one of the respective water supply channels 37a, 37b and 37c.

In this case, the water, supplied into the liquid detergent receiving chamber 42, is mixed with the liquid detergent, and thus if the mixture of the wash water and liquid detergent is filled over a predetermined level, the liquid flows toward the outlet 40 through the siphon 50 and the discharge opening 42d.

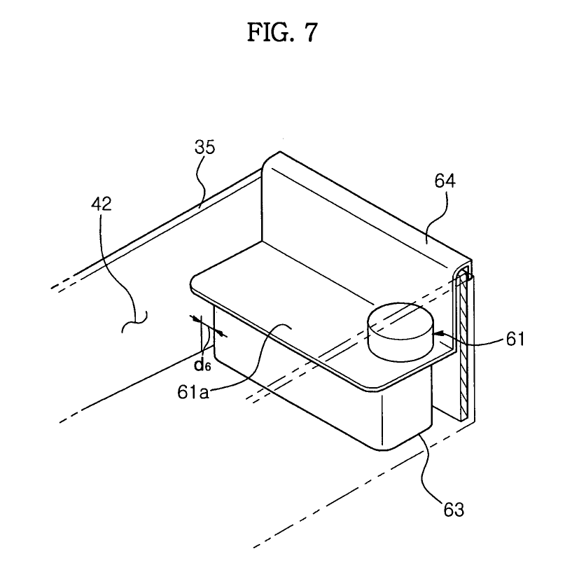

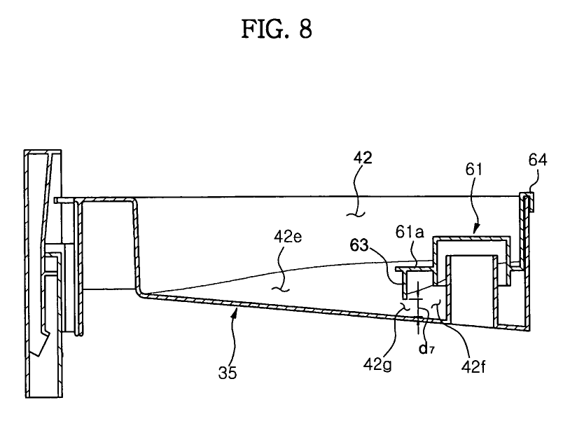

Referring to FIGS. 7 and 8, illustrating another embodiment of the present invention, the detergent supply device 30 is modified such that a partition 63 is integrally formed with a level marker 61a, instead of being attached to an inner wall of the detergent container 35.

In order to integrally form the partition 63 with the level marker 61a, the level marker 61a is widened as compared to the above embodiment, such that it has approximately the same width as the liquid detergent receiving chamber 42, and is extended by a prescribed length toward the front end of the detergent container 35. The partition 63, extending downward from the level marker 61a, has a width narrower than that of the level marker 61a, such that front, left and right ends thereof are inwardly spaced apart from the front, left and right ends of the level marker 61a by a predetermined distance (d₆). As shown in FIG. 8, a lower end of the partition 63 is spaced apart from the bottom surface of the detergent container 35 by a predetermined distance (d₇), such that a liquid passage 42g is defined between the lower end of the partition 63 and the bottom surface of the detergent container 35. The liquid detergent receiving chamber 42 is divided into front and rear spaces 42e and 42f on opposite sides of the partition 63.

Therefore, even if a shock is applied to the detergent container 35 to cause the liquid detergent, filled in the liquid detergent receiving chamber 42, to tilt from side to side, it is possible to prevent malfunction of the siphon 50.

Meanwhile, at a rear end of a siphon cap 61 is formed a fixture portion 64 for fixing the siphon cap 61 to a rear wall of the detergent container 35, such that the siphon cap 61 can be securely supported on the detergent container 35.

As is apparent from the above description, a washing machine having a detergent supply device in accordance with the embodiments of the present invention includes a partition capable of reducing level differences of liquid detergent, thereby preventing the liquid detergent from being prematurely supplied into a water tub.

Although embodiments of the present invention have been shown and described, it would be appreciated by those skilled in the art that changes may be made in these embodiments without departing from the principles and spirit of the invention, the scope of which is defined in the claims and their equivalents.

1. A washing machine comprising:
a washing tub; and
a detergent supply device, the detergent supply device comprising:
a plurality of water supply pipes,
a housing having a plurality of inlets respectively connected with the water supply pipes, and an outlet connected with the washing tub,
a detergent container detachably inserted in the housing and internally defining a first liquid detergent receiving chamber, the detergent container having a discharge member for discharging a first liquid detergent, filled in the first liquid detergent receiving chamber, into the washing tub, and
a restrictive element to prevent the liquid detergent inside the detergent container from moving from side to side upon receiving an external force.

2. The washing machine according to claim 1, wherein the discharge member is a siphon.

3. The washing machine according to claim 2, wherein the siphon comprises a level marker to display a level of the first liquid detergent supplied in the first liquid detergent receiving chamber.

4. The washing machine according to claim 3, wherein the restrictive element is integrally formed with the level marker.

5. The washing machine according to claim 4, wherein the level marker comprises with a fixture portion to fix the level marker to the detergent container.

6. The washing machine according to claim 1, wherein the restrictive element is a partition to divide the first liquid detergent receiving chamber into front and rear spaces.

7. The washing machine according to claim 6, wherein the partition has a width narrower than a width of the first liquid detergent receiving chamber, thereby defining a liquid passage on a side thereof.

8. The washing machine according to claim 6, wherein the partition is vertically installed in a center of the first liquid detergent receiving chamber.

9. A washing machine comprising:
a body having a washing tub;
a detergent container in the body and having a water supply portion and a water discharge portion;
a siphon in the water discharge portion; and
a restrictive element adapted to prevent a liquid, in the detergent container, from being prematurely discharged through the siphon when the detergent container receives an external force.

10. The washing machine according to claim 9, wherein the restrictive element includes a restrictive plate located in a vicinity of the water discharge portion and to prevent the liquid from being pushed toward the water discharge portion upon receiving the external force.

11. A washing machine comprising:
a body containing a washing tub;
a detergent supply device in the body,
wherein the detergent supply device comprises:
a detergent container,
an upper case internally defining water supply channels, and
a lower case to slidingly receive the detergent container, the detergent container being between the upper and lower cases,
wherein the detergent container comprises:
a water supply portion to receive wash water through the water supply channels and liquid detergent from the outside, and
a water discharge portion to discharge the liquid detergent filled in the detergent container,
wherein the water discharge portion comprises a siphon mechanism; and
a restrictive element is in the vicinity of the siphon mechanism, and prevents the liquid detergent in the detergent container from being prematurely discharged through the siphon mechanism when an external force is applied to the detergent container.

12. A washing machine comprising:
a washing tub; and
a liquid detergent receiving chamber to contain a detergent, the detergent being discharged to the washing tub at a predetermined time,
wherein the detergent is not discharged to the washing tub prior to the predetermined time due to an external force received by the liquid detergent receiving chamber.

13. The washing machine according to claim 12, further comprising a partition to divide the liquid detergent receiving chamber into first and second portions.

14. The washing machine according to claim 13, wherein the partition restricts free movement of the liquid detergent between the first and second portions.
